(19) United States
(12) Patent Application Publication
(10) Pub. No.: US 2006/0206265 A1
(43) Pub. Date: Sep. 14, 2006

(54) GPS device and method for displaying two locations simultaneously

(76) Inventors: John Cross, Overland Park, KS (US); Christopher Lalik, Overland Park, KS (US); John DeCastro, Lenexa, KS (US); Richard Ball, Overland Park, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/074,505

(22) Filed: Mar. 8, 2005

(51) Int. Cl. G01C 21/32

(52) U.S. Cl. 701/213; 701/211

(57) ABSTRACT

A GPS device and method for quickly and automatically determining and implementing an appropriate scale or area for displaying simultaneously at least a current location and a previously designated or otherwise identified waypoint, trail, track, or other geo-referenced indicator associated with a location. Relative distance, direction, and other useful navigation information may also be determined and displayed.

### BACKGROUND OF THE INVENTION

1. Field of the Invention

The present invention relates broadly to hand-held electronic GPS-based navigation aids and related methods for facilitating navigation. More particularly, the present invention concerns a GPS device and method for quickly and automatically determining and implementing an appropriate scale or area for displaying simultaneously (i.e., at the same time) at least a current location and a previously designated or otherwise identified waypoint, trail, track, or other geo-referenced indicator associated with a location. Relative distance, direction, and other useful navigation information may also be determined and displayed.

2. Description of the Prior Art

Outdoor enthusiasts, such as sportsmen, vacationers, and athletes, increasingly use hand-held electronic global positioning system (GPS) devices to navigate while afield. Commonly-available GPS devices typically include at least a processor, a receiver, and an antenna for receiving position signals from a plurality of known locations (e.g., from satellites in orbit) and, through a process of geometric triangulation, determining the relative location of the GPS device in terms of latitude, longitude, and even altitude.

All such devices allow users to display their own current location, and many such devices allow users to designate or otherwise create and display waypoints, trails, tracks, and other geo-referenced indicators corresponding to locations. Unfortunately, over time, as the user moves, these indicators may become sufficiently removed from the user's current location that they no longer appear in the same display screen. When this happens, in order to view both the current location and a previously designated or otherwise identified geo-referenced indicator the user must re-scale the display to show a greater amount of area, pan the display to show a different area, or perform some combination thereof. This can be time-consuming and frustrating, especially if numerous manipulations are required.

Due to these and other disadvantages in the prior art, a need exists for a GPS device capable of more quickly and easily displaying simultaneously a current location and a previously designated or otherwise identified waypoint or other location.

### SUMMARY OF THE INVENTION

The present invention overcomes the above-described and other disadvantages in the prior art by providing a GPS device and method for quickly and automatically determining and implementing an appropriate scale or area for displaying simultaneously at least a current location and a previously designated or otherwise identified waypoint, trail, track, or other geo-referenced indicator associated with a location. Relative distance, direction, and other useful navigation information may also be determined and displayed.

The GPS device is adapted and operable to allow for determining and displaying the user's current location and an area surrounding that location. The GPS device is also adapted and operable to allow for designating or otherwise identifying and displaying the aforementioned geo-referenced indicators and areas surrounding those locations. The present invention provides a function which, when activated, immediately and automatically determines and implements appropriate zooming, panning, or both to display the user's current location and the particular indicator simultaneously. The function may be implemented so as to default to zooming or panning to display the user's current location and the nearest indicator simultaneously. Additionally, the function may be further implemented so as to, with each additional activation, zoom or pan to include the next nearest indicator. Additionally or alternatively, the function may allow the user to select a specific indicator, which may or may not be the nearest indicator, for simultaneous display. A dedicated physical or virtual button or other selectable device is provided for such activation, thereby further enhancing the quickness and ease with which the user may accomplish his or her desire.

Thus, it will be appreciated that the GPS device and method of the present invention provide a number of substantial advantages over the prior art, including, for example, allowing the user to quickly and efficiently adjust the display so that the user's current location and a particular indicator appear simultaneously, thereby avoiding the need to search for the particular indicator by tediously performing multiple manual manipulations.

These and other important features of the present invention are more fully described in the section titled detailed description of a preferred Embodiment, below.

### BRIEF DESCRIPTION OF THE DRAWINGS

A preferred embodiment of the present invention is described in detail below with reference to the attached drawing figures, wherein:

FIG. 1 is a block-diagram depiction of a preferred embodiment of a GPS device of the present invention;

FIG. 2 is a first high-level flowchart of steps involved in practicing a preferred embodiment of the method of the present invention;

FIG. 3 is a second high-level flowchart of additional or alternative steps involved in practicing the preferred embodiment of the method of the present invention; and

FIG. 4 is a third high-level flowchart of additional or alternative steps involved in practicing the preferred embodiment of the method of the present invention.

### DETAILED DESCRIPTION OF THE PREFERRED EMBODIMENT(S)

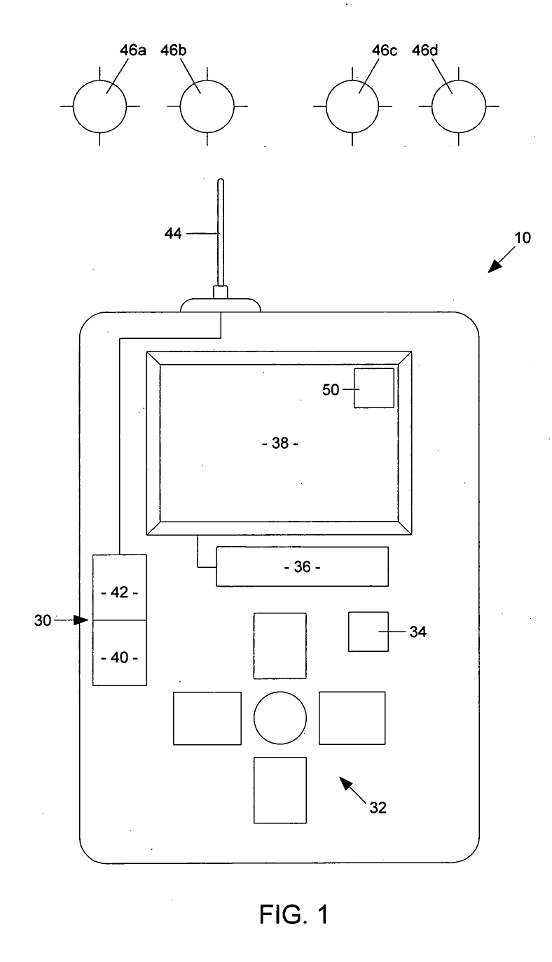

With reference to the figures, a GPS device 10 and method are herein described, shown, and otherwise disclosed in accordance with the preferred embodiment(s) of the present invention. More specifically, referring to FIG. 1, the present invention concerns a GPS device 10 and method for quickly and automatically determining and implementing an appropriate scale or area for displaying simultaneously (i.e., in the same display) at least a current location and a previously designated or otherwise identified waypoint, trail, track, or other. geo-referenced indicator associated with a location. Relative distance, direction, and other useful navigation information may also be determined displayed.

The GPS device 10 is adapted and operable to allow for determining and displaying the user's current location and an area surrounding that location. The GPS device 10 is also adapted and operable to allow for designating or otherwise identifying and displaying waypoints, trails, tracks, or other geo-referenced indicators and areas surrounding those indicators. As the user moves, the user's current location and a particular previously-identified geo-referenced indicator may no longer be sufficiently close to appear together in the area displayed. When this happens, and the user wishes to view both his or her current location and the particular indicator simultaneously, the user can manually increase the scale of the display (i.e., zoom out) to show more of the surrounding area until the particular indicator appears. Alternatively, the user can manually “move” the display (i.e., pan) to show adjacent areas until the particular indicator is found, and then, as necessary, increase the scale of the display to show more of the surrounding area until the user's current location appears. These manual techniques, however, can be time-consuming and frustrating, especially if the user must search for the particular indicator by tediously performing multiple manual manipulations.

The present invention provides an alternative to these manual techniques whereby the user can much more quickly and efficiently achieve his or her desire. This is accomplished by a function which, when activated, immediately and automatically determines and implements appropriate zooming, panning, or both to display the user's current location and the particular indicator simultaneously. This function may be implemented using any suitable hardware, software, or firmware mechanism. The details of creating and implementing the feature may vary considerably depending on the particular hardware, software, or firmware technology of the particular GPS device and the particular technological standards used by the particular GPS device, but such creation and implementation is considered to be within the ability of one with ordinary skill in the art without requiring undue experimentation. Activation of the function may be achieved using a physical or virtual button, switch, or other selectable device, as discussed below.

It is contemplated that the function may be implemented so as to default to zooming or panning to display the user's current location and the nearest indicator simultaneously. Additionally, the function may be further implemented so as to, with each additional activation, zoom or pan to include the next nearest indicator. In this further implementation, the additional activation may be required to be made within a pre-established time period or else the function may return to the default mode. Furthermore, this further implementation may be such that the current location and the next nearest indicator are displayed simultaneously without regard to whether the nearest indicator continues to be displayed, or, alternatively, such that the current location, next nearest indicator, and nearest indicator are all displayed simultaneously. Additionally or alternatively, the function may allow the user to select a specific indicator, such as from a list or other menu, which may or may not be the nearest indicator, for simultaneous display.

It is also contemplated that any one or more of a variety of relevant useful information may be displayed as well. For example, the function may cause to be displayed a virtual pointer pointing to the particular indicator, and, if desired, this virtual pointer may remain even after the user zooms or pans the display in such a manner that the current location and the particular indicator are no longer displayed simultaneously. Thus, even though the particular indicator is no longer displayed, the virtual pointer continues to inform the user of the direction to its location. Additionally or alternatively, the function may cause to be displayed certain textual information such as, for example, the relative distance and direction from the user's current location to the particular indicator.

A preferred embodiment of the GPS device 10 broadly comprises a GPS unit 30; an input interface 32, including a button 34 for activating the aforementioned function; a processor 36; and an output display 38. It will be appreciated that devices using GPS technology for determining location are well-known to those with ordinary skill in the art, and therefore the present disclosure focuses primarily on the claimed features that comprise the present invention, rather than on said basic technology. The GPS device 10 as a whole is preferably appropriately designed and constructed so as to be lightweight, rugged, waterproof, and otherwise resistant to relatively harsh environments and operating conditions.

The GPS unit 30 includes at least a processor 40, a receiver 42, and an antenna 44 for, in a conventional manner, receiving position signals from a plurality of known locations 46a,46b,46c,46d (from, e.g., satellites in orbit) and, through a process of geometric triangulation, determining the relative location of the GPS unit 30.

The input interface 32 allows the user to enter information and to affect control when prompted or otherwise as may be desired or appropriate. As such, the input interface 32 may take any appropriate form and use any available input technology such as, for example, keypad, touch-screen, or scroll-wheel technologies. The button 34 provides a physical control mechanism allowing the user to, as earlier discussed, activate the function which causes the GPS device 10 to immediately and automatically determine and implement appropriate zooming or panning to display the user's current location and the particular indicator simultaneously. Additionally or alternatively, a virtual button or other selectable device 50 may be provided via the display 38 which is selectable to activate the function using substantially any conventional selection mechanism or technology. The button 34,50, whether physical or virtual, is preferably a dedicated control mechanism requiring only a single activation to initiate the function, thereby further enhancing the quickness and ease with which the user may accomplish his or her desire.

The processor 36 performs a number of operations, including executing the function and determining the appropriate zooming or panning adjustments to make to the display. The output display 38 allows the GPS device 10 to communicate with the user, including presenting selections and/or prompting the user to make a selection, and to display various images and other information. As such, the output display 38 may take any appropriate form and use any available technology such as, for example, liquid crystal display (LCD) technology.

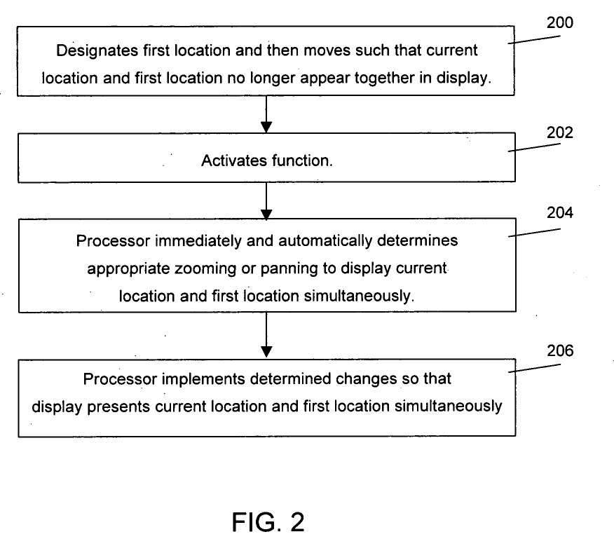

Referring to FIG. 2, in contemplated exemplary but non-limiting use and operation, the present invention may be characterized as functioning in accordance with the following steps. The user designates or otherwise identifies a first location as a waypoint and thereafter moves for such a distance or direction that the user's current location and the first location are no longer sufficiently close to appear together in the area currently displayed in the output display 38 of the GPS device 10, as depicted in box 200. Later, the user, wishing to view both his or her current location and the first location in the same display, depresses or otherwise selects the button 34,50 to activate the function, as depicted in box 202. The processor 36, in executing the function, immediately and automatically determines appropriate zooming or panning to display the user's current location and the first location simultaneously, as depicted in box 204. The processor 36 then implements the determined changes so that the display presents the current location and the first location simultaneously, as depicted in box 206.

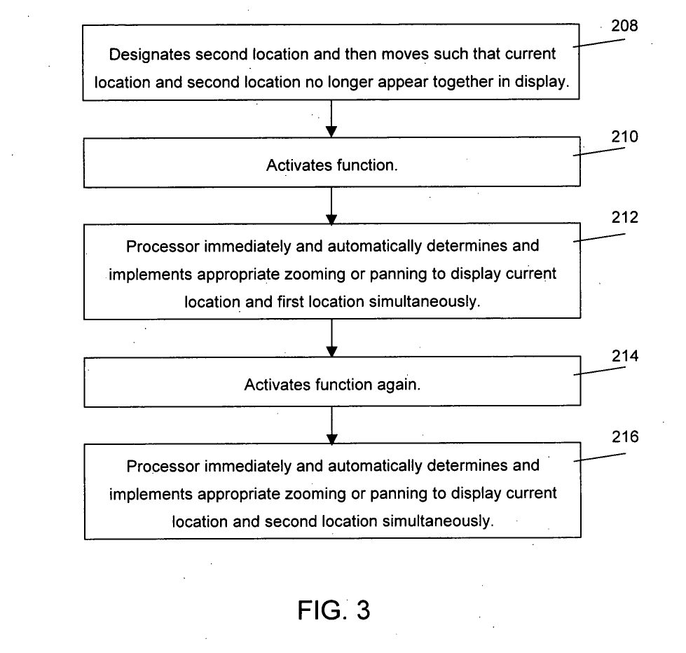

Referring to FIG. 3, in additional or alternative exemplary but non-limiting use and operation, the user designates an additional second location and thereafter moves for such a distance and direction that the user's current location and the second location are no longer sufficiently close to appear together in the area currently displayed on the GPS device 10, as depicted in box 208. Later, the user, wishing to view both his or her current location and the second location in the same display, depresses or otherwise selects the button 34,50 to activate the function, as depicted in box 210. The processor 36, in executing the function, by default immediately and automatically determines and implements appropriate zooming or panning to display the user's current location and the first location simultaneously, as depicted in box 212. The user again depresses or otherwise selects the button 34,50 to activate the function, as depicted in box 214. The processor 36, in executing the function again, immediately and automatically determines and implements appropriate zooming or panning to display the user's current location and the second location simultaneously, as depicted in box 216.

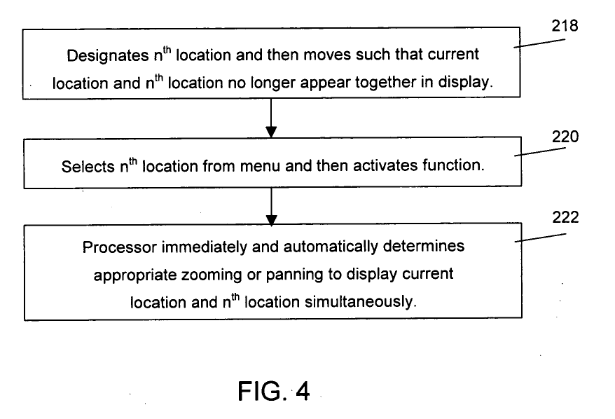

Referring to FIG. 4, in additional or alternative exemplary but non-limiting use and operation, the user designates additional multiple locations, including a tenth location, and thereafter moves for such a distance and direction that the user's current location and the tenth location is no longer sufficiently close to appear together in the area currently displayed on the GPS device 10, as depicted in box 218. Later, the user, wishing to view both his or her current location and the tenth location in the same display, but not wishing to depress or otherwise select the button 34,50 ten times to activate the function ten times, selects the tenth location directly from a list or other menu of locations and then activates the function, as depicted in box 220. The processor 36, in executing the function, immediately and automatically determines and implements appropriate zooming or panning to display the user's current location and the selected tenth location simultaneously, as depicted in box 222.

From the preceding discussion it will be appreciated that the GPS device and method of the present invention provide a number of substantial advantages over the prior art, including, for example, allowing the user to quickly and efficiently adjust the display so that the user's current location and a particular indicator appear simultaneously, thereby avoiding the need to search for the particular indicator by tediously performing multiple manual manipulations.

Although the invention has been described with reference to the preferred embodiments illustrated in the attached drawings, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A method of displaying at least two locations simultaneously on a display component of a GPS device, the method comprising the steps of:
(a) allowing for identifying a first location;
(b) determining a current location;
(c) determining automatically a change in a current display sufficient to simultaneously display both the first location and the current location; and
(d) implementing automatically the change in the current display so as to simultaneously display both the first location and the current location on the display component.

2. The method as set forth in claim 1, wherein the first location is a waypoint.

3. The method as set forth in claim 1, wherein the change in the current display involves a change in scale to display a different amount of area.

4. The method as set forth in claim 1, wherein the change in the current display involves displaying an at least partially different area.

5. The method as set forth in claim 1, further including the step of determining and displaying information regarding a relative distance and a relative direction from the current location to the first location.

6. The GPS device operable to implement the method set forth in claim 1.

7. A method of displaying at least two locations simultaneously on a display component of a GPS device, the method comprising the steps of:
(a) allowing for identifying a first location;
(b) allowing for identifying a second location;
(c) determining a current location;
(d) determining automatically, in response to a first activation, a change in a current display sufficient to simultaneously display both the first location and the current location;
(e) implementing automatically the first change in the first current display so as to simultaneously display both the first location and the current location on the display component;
determining automatically, in response to a second activation, a second change in the current display sufficient to simultaneously display both the second location and the current location; and
(g) implementing automatically the second change in the current display so as to simultaneously display both the second location and the current location on the display component.

8. The method as set forth in claim 7, wherein the first location is a waypoint.

9. The method as set forth in claim 7, wherein the change in the current display involves a change in scale to display a different amount of area.

10. The method as set forth in claim 7, wherein the change in the current display involves displaying an at least partially different area.

11. The method as set forth in claim 7, further including the step of determining and displaying information regarding a relative distance and a relative direction from the current location to the first location.

12. The GPS device operable to implement the method set forth in claim 7.

13. The GPS device as set forth in claim 12, further including a dedicated control mechanism which when activated a first time accomplishes the first actuation, and which when activated a second time accomplishes the second actuation.

14. A method of displaying at least two locations simultaneously on a display component of a GPS device, the method comprising the steps of:
(a) allowing for identifying multiple locations;
(c) determining a current location;
(d) allowing a user to select one of the multiple locations;
(e) determining automatically, in response to an activation, a change in a current display sufficient to simultaneously display both the selected one of the multiple locations and the current location; and
(f) implementing automatically the change in the current display so as to simultaneously display both the selected one of the multiple locations and the current location on the display component.

15. The method as set forth in claim 14, wherein one or more of the multiple locations is a waypoint.

16. The method as set forth in claim 14, wherein the change in the current display involves a change in scale to display a different amount of area.

17. The method as set forth in claim 14, wherein the change in the current display involves displaying an at least partially different area.

18. The GPS device operable to implement the method set forth in claim 14.

19. The GPS device as set forth in claim 19, further including a dedicated control mechanism which when activated a first time accomplishes the first actuation, and which when activated a second time accomplishes the second actuation.
